(19) United States
(12) Patent Application Publication
(10) Pub. No.: US 2012/0315140 A1
(43) Pub. Date: Dec. 13, 2012

(54) PASSIVE CONVERTER

(76) Inventors: Alex De Broe, Asse (BE); Alex Van Den Bossche, Herzele (BE)

(21) Appl. No.: 13/575,427

(22) PCT Filed: Apr. 27, 2010
(86) PCT No.: PCT/EP10/55637

§ 371 Date: Jul. 26, 2012

(30) Foreign Application Priority Data
Jan. 29, 2010 (BE) 2010/0049

(51) Int. Cl. F03D 7/00; F03D 11/00

(52) U.S. Cl. 416/1

(57) ABSTRACT

The invention describes a method for maximum power point tracking approximation and speed control of a wind turbine using an AC-DC converter consisting of “passive” components only. The proposed system only uses passive electrical components or semiconductors such as inductors, capacitor or diodes. In the proposed concept this is done by designing an electric circuit so that it loads the generator output in such a way as to realize a pre-defined torque-frequency characteristic. By carefully choosing the values of the different components, the circuit can be tuned to fit an ideal torque-frequency curve. This torque characteristic is close to the maximum-power tracking control law up to the rated rotor speed, and steeply rises beyond that speed in order to maintain the rotor speed within a certain range and prevent turbine runaway.

### FIELD OF THE INVENTION

The invention describes a method for maximum power point tracking approximation and speed control of a wind turbine using an AC-DC converter consisting of “passive” components only. The proposed system only uses passive electrical components or semiconductors such as inductors, capacitor or diodes.

In the proposed concept this is done by designing an electric circuit so that it loads the generator output in such a way as to realize a pre-defined torque-frequency characteristic. By carefully choosing the values of the different components, the circuit can be tuned to fit an ideal torque-frequency curve. This torque characteristic is close to the maximum-power tracking control law up to the rated rotor speed, and steeply rises beyond that speed in order to maintain the rotor speed within a certain range and prevent turbine runaway.

### BACKGROUND

### Wind Turbine Power Control

In general, wind turbines are designed to yield maximum power output at all wind speeds below rated; and to limit the power output to the nominal power of the drive train (gearbox, if present, and generator) above the rated wind speed. In case of high winds it is thus necessary to waste part of the excess energy of the wind in order to avoid damaging the wind turbine. All wind turbines are therefore designed with some sort of power control to track the optimum operating point below rated wind speed and to limit the incoming power above rated wind speed.

Limiting the incoming power and the turbine rotor speed can either be done using the stall principle or by using a pitch mechanism.

The simplest form of power control is passive stall control, which makes use of the post-stall reduction in lift coefficient and associated increase in drag coefficient to place a ceiling on output power as wind speed increases. The blades are designed to create turbulence at wind speeds above a certain threshold, preventing the lifting force of the rotor blade from acting on the rotor.

The basic advantage of stall control is that one avoids moving parts in the rotor itself. On the other hand, stall control represents a very complex aerodynamic design problem, and related design challenges in the structural dynamics of the whole wind turbine, e.g. to avoid stall-induced vibrations. Also stall-controlled machines need to have a rather steep generator torque vs. rotor speed characteristic to maintain the machine at rated rotor speed in high wind conditions and avoid over-speed.

Active pitch control achieves power limitation above the rated wind speed by rotating all or part of each blade about its axis in the direction which reduces the angle of attack and hence the lift coefficient—a process known as blade feathering. The power produced by the turbine is monitored and fed back to an electronic controller which steers a blade pitch mechanism. This work is performed by a hydraulic or electromechanical mechanism, which renders the turbine expensive, but above all, moving structural elements are prone to malfunctions, failures and high maintenance cost. [The Wind Energy Handbook, Wiley].

Active stall control achieves power limitation above rated wind speed by pitching the blades initially into stall, i.e., in the opposite direction to that employed for active pitch control. One of the advantages of active stall is that the power output can be more accurately controlled than with passive stall, but as with pitch control, it requires a complex controller system and a pitch actuator.

Variable-Speed vs. Fixed-Speed Wind Turbines

For energy yield maximization at below-rated wind speeds and also for reduction of mechanical loads, variable speed wind turbines, where the rotational speed of the rotor can vary in a predefined range, are preferred over fixed speed turbines. Typically, variable speed generation strategies vary the rotational speed of the turbine, by controlling the torque delivered by the wind turbine generator. This results in a constant tip-speed ratio of the turbine (ratio of the rotor blade tip speed over the wind speed). As such, they constantly adapt the operating point of the turbine to the wind speed to extract the maximum amount of power. This is known as a maximum power point tracking.

### PRIOR ART

In all prior art related to optimum power point tracking in wind turbines, variable-speed drives consist of a power-electronic converter that in one way or another senses the power output generated by the generator and/or senses other variables such as rotor speed for example, and applies an algorithm to determine the optimum generator torque. It is qualified as an active system since there is an intelligence that measures and compares actual values with target values and actively changes the operating point to correct for possible differences between those. This is achieved by actuating one or more mechanical systems of the turbine to make it go in the optimal operational regime. Due to the complexity of such systems (high parts count, numerous connections . . . ) their reliability is often disappointing.

Wind turbine electrical and electronic systems tend to be the weak link in the complete system. Due to the very high number of connections and sensitivity of the type of components involved (microcontrollers, sensors, power-semiconductors) the Mean-Time-Between-Failure of these subsystems is the lowest among all systems in a wind turbine. Although these type of failures are in general relatively easy to repair, the amount of downtime highly dependent upon the organization and logistics of the maintenance service. In easily accessible sites (on-shore wind power for bulk power generation in industrialized countries) repairs will be done swiftly thanks to automated error alarms and an effective O&M crew. For other type of applications, such as offshore wind power or distributed wind power in remote regions, accessibility is such that frequent maintenance or rapid interventions are impossible and even minor failures will result in long outages.

Most prior art concerning the maximum power point tracking of wind turbines proposes systems including active components including power-electronic switches and control circuit. Below is a list of relevant prior art:
United States Patent Application 20070170724—Jul. 26, 2007 Stall controller and triggering condition control features for a wind turbine: This patent proposes an active system, including a power-electronic converter, to regulate the generator torque for maximum power tracking and power limiting. It is only during emergency conditions, in case of e.g. converter or control circuit failure, that a simple passive means (short-circuiting the generator stator windings) is proposed to limit the rotor speed.
CN101378201 (A)—2009 Mar. 4 Passive control type wind power generation system capable of automatically tracking maximum wind energy. This invention addresses the same problems and describes a passive way of doing maximum power point tracking. The proposed solution however requires multiple windings in the generator and also the problem of over-speed protection is not addressed.
“ANALYSIS OF WIND POWER FOR BATTERY CHARGING”, Eduard Muljadi et al. Wind Technology Division National Renewable Energy Laboratory (Colorado, US); Proceedings of the Industry Applications Conference, 1996. This paper investigates the properties of the system consisting of a permanent-magnet generator connected to a battery bank via a rectifier. It proposes two ways to improve its performance: an active solution requiring a DC-DC converter in between the rectifier and the battery bank and a passive solution using a series-capacitor compensation. The authors however confirm that series-compensation with capacitors only is not an ideal solution since the torque-speed characteristic only matches the optimal control law in a part of the operation range. The power curve goes drops off dramatically beyond the maximum torque point since the full torque frequency is determined by resonance of leakage inductance and the capacitor. They therefore suggest to combine both active and passive solutions.

### “Passive” Control

The invention describes a method for maximum power point tracking approximation and speed control of a wind turbine using an AC-DC converter consisting of “passive” components only. The proposed system only uses passive electrical components or semiconductors such as inductors, capacitor and diodes.

In the proposed concept this is done by tuning an electric circuit so that it loads the generator output in such a way as to realize a pre-defined torque-frequency characteristic. This torque characteristic matches the ideal control law up to the rated rotor speed, and then implements a steep torque increase once the rated rotor speed has been reached to avoid turbine runaway.

If the turbine would include another means of limiting the incoming power above rated speed (such as an active pitch mechanism), there would be no need for the steep increase in generator torque beyond the rated rotor speed. The pitch mechanism will limit the incoming power by adjusting the blade pitch and rotor over-speed conditions will be avoided.

It is clear that the present invention is thus compatible with stall- and pitch controlled turbines, even though the desired torque vs. rotor speed characteristic is slightly different above rated rotor speed in both cases.

There exist various electrical schemes that can be tuned to approximate the desired torque-frequency curve. Some of these will be described in the preferred embodiments section, but it is apparent that these preferred embodiments do not limit the scope of the invention. It is clear that any circuit tuned in such a way that it has the intention to optimize the electrical load for optimal power point tracking approximation in wind turbines falls under the scope of this invention.

It is even so that one could envisage implementing the inductors or capacitors of the circuit with parasitic components (leakage inductance of the generator or transformer connected to the generator output, parasitic capacitance of the generator or transformer). That way the invention even further reduces the cost of wind turbine control limiting the number of dedicated components to the diode rectifiers only.

Systems using only one rectifier exist, and also solutions with only series capacitors and without inductors exist. However these solutions only obtain a good match of the torque-speed curve with the optimal one if the resistive losses are high and thus efficiency is low.

This invention aims at decreasing fabrication cost and maintenance & operation cost of the generator, due to the robustness and the high reliability of the components used. The invention is particularly of interest in offshore application where the generator-side converter is located in the nacelle (at sea) and the grid-side converter could be located on-shore (in case of using a centralized grid converter and realizing the collector-grid in DC). Also for small (<1 kW) it might be useful in case they have a DC output (no grid-side converter) or the converter is located inside the house (residential applications) and the generator-side converter is subjected to harsh environmental conditions.

### SUMMARY OF THE INVENTION

The present invention provides methods and tools for maximum power point tracking approximation and/or speed control of a wind turbine.

In a first aspect, methods for maximum power point tracking approximation and/or speed control of a wind turbine are provided using at least one AC-DC converter consisting of an electrical circuit comprising solely ‘passive’ components or elements.

In particular embodiments, the methods of the invention make use of at least one inductor and diode. In further particular embodiments, the methods of the invention make use of at least one capacitor and diode. In further particular embodiments, the methods of the invention make use of at least one autotransformer and diode.

In particular embodiments of the methods according to the invention the passive elements are tunable (by taps, air gap or combination of elements) to load the generator output in such a way as to realize a pre-defined torque-frequency characteristic before installation of the wind turbine.

In particular embodiments of the methods according to the invention, the passive elements are tunable to load the generator output in such a way as to realize a torque-frequency characteristic after installation of the wind turbine.

A further aspect of the invention provides methods for maximum power point tracking approximation and/or speed control of a wind turbine wherein the methods make use of at least one AC-DC converter consisting of an electrical circuit comprising solely ‘passive’ components, so that it loads the generator output in such a way that it matches the ideal control law up to the rated rotor speed, and then implements a steep torque increase once the rated rotor speed has been reached to avoid turbine runaway.

In particular embodiments of these methods, use is made of at least one inductor and diode.

In particular embodiments of these methods, use is made of at least one capacitor and diode.

In particular embodiments of these methods, use is made of at least one autotransformer and diode.

In particular embodiments of the methods of the invention, the passive elements are tunable before installation of the wind turbine. In further particular embodiments, the passive elements are tunable after installation of the wind turbine.

A further aspect of the invention relates to tools for performing the methods described above. More particularly, the invention provides circuits for maximum power point tracking approximation and/or speed control of a wind turbine adapted for us in the methods of the present invention.

### DESCRIPTION OF THE INVENTION

The power in the wind varies as the cube of the wind speed. Rotors consisting of an assembly of blades using aerodynamically-shaped airfoils, achieve their peak efficiency in converting the kinetic energy from the wind in torque on the wind turbine rotor axis at a certain ratio of rotational speed and wind speed. This ratio is usually given as the tip-speed-ratio (ratio of the speed of the tip of the rotor blades over the wind speed). To achieve maximum power extraction, the turbine rotor speed needs to be adjusted continuously to the wind speed up to a maximum rotor speed (angular velocity of the rotor). The ideal control law would match the power extracted from the generator to the maximum power available in the wind and thus vary the power with the cube of the rotor speed to keep the turbine at the optimum tip-speed-ratio.

The output produced by the turbine, if losses are disregarded, is the product of the rotor speed and the torque of the rotor. Consequently, the ideal control law for generator torque establishes a variation of the torque as the square of the rotor speed and thus, in the case of a synchronous generator, the generator frequency. In the case of a synchronous generator the wind turbine rotor speed is directly linked to the fundamental frequency of the generator current and voltage via the number of magnetic poles in the generator rotor.

There are many possible schemes fulfilling the requirement above. In principle, any circuit using interconnected impedances, diodes or (auto)-transformers could be used to achieve the desired effect. The more complex the circuit, the better the resulting torque-frequency curve will match the optimal control law but parts count will be higher and thus the possible losses in the circuit.

This invention describes different preferred embodiments, based on experience and knowledge of the inventors. The values of the components have been chosen in the applied settings to fit the ideal characteristic to a certain level of accuracy, as a trade-off between performance and cost of the total system. The use of these values and their description below in no case limits the scope of the invention. Different values of the components and different placements in the circuit are subject of the invention matter.

### Preferred Embodiments

The generator is modeled using a voltage source, tunable for certain frequency-voltage ratio, and a leakage inductance. The output of the passive electrical circuit is connected to a fixed-voltage Direct-Current (DC) bus representing the DC-link of a grid-connected converter or a battery bank. The power-frequency curves in the following paragraphs are created using Capture CIS (OrCAD), PSpice A/D (a mixed-signal simulator) and Mathcad (Parametric Technology Corporation).

### Single-Phase Equivalent Schemes

In order to reduce the complexity of simulations, preferred embodiments of the invention are first developed as single-phase equivalent circuits.

1. Single Phase Simulation Scheme with External Inductance.

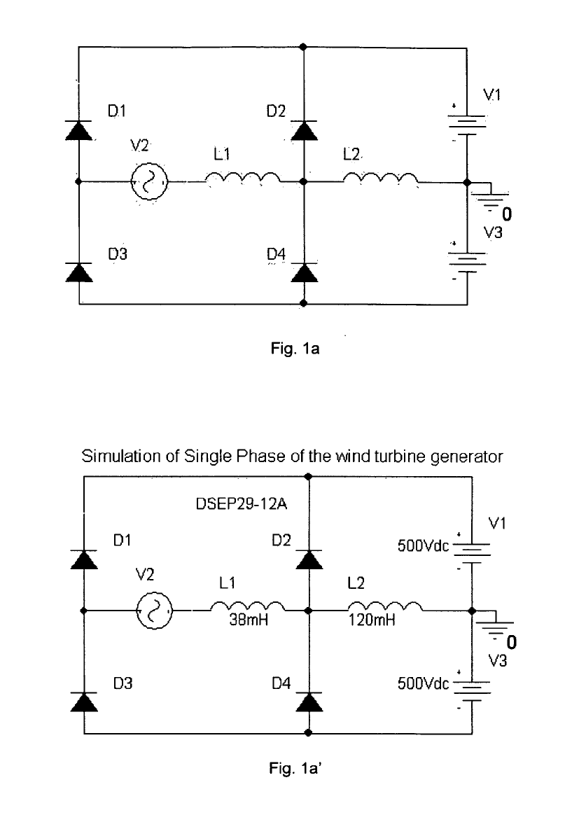

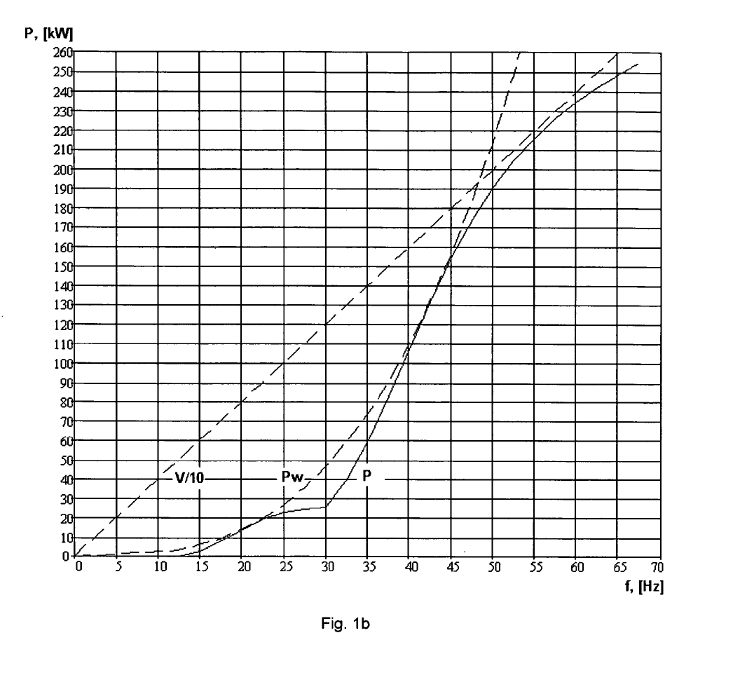

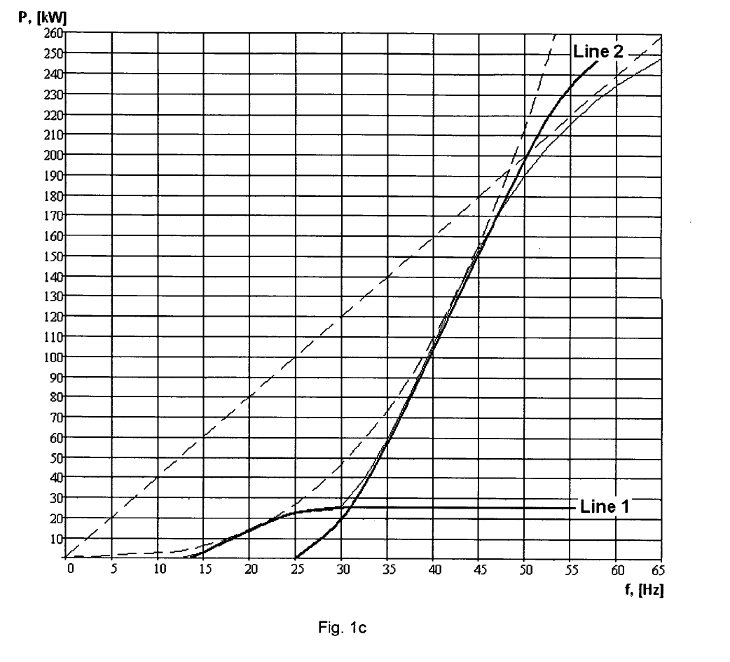

The circuit on FIG. 1a represents the concept of a full bridge rectifier. The circuit on FIG. 1a′ represents this concept with specified values used in the simulations and measurements. The values of the components in the scheme are:

1) Generator inductance—38 mH
2) External inductance—120 mH
3) EMF constant—40V/Hz
4) DC voltage—1000V

Graphic on FIG. 1b shows the resulting power-frequency curve. The three curves that are shown are the power curve (marked with P measured in kW), the kinetic power available in the wind varying with the cube of the wind speed (marked with Pw), and the curve showing the linear frequency/voltage relation (marked with V/10 and divided by a factor 10 to be shown on the graph).

At low frequency the impedance of the external inductor is small and acts as a short circuit. Diodes D1 and D3 are used only at this rotating speed. However, at higher frequency the impedance is high and the inductor acts rather like an open circuit. The resulting curve has a significant power drop in the middle area. So, in a three phase circuit this would mean that at low frequency the generator windings are connected in “star” topology by the external inductors and at high rotation speed the generator winding topology is rather a “delta” configuration.

The high frequency area in FIG. 1b is determined by the generator leakage inductance value. Decreasing the leakage inductance increases the maximum power and vice versa. However this value determines the generators size. Decreasing of this value means bigger generator, which is undesired.

The maximum power can also be reduced or increased by changing the value of the electromagnetic force (EMF) of the generator. This also determines the size of the generator. Also the inception point of the graphic (frequency at which power starts to flow) depends on the EMF value. This is the point where the peak value of the EMF is bigger than half of the supply voltage. Lower EMF values lead to higher inception point and vice versa. The external inductance influences mainly the lower frequency area on the power-frequency curve. Its value can be adapted to fit the ideal cubic curve. Increasing the inductance leads to a decreasing power at the lower area of the graphic and vice versa.

The first curve (Line 1) in FIG. 1c shows the power-frequency graphic of the external inductor influence and its maximum power that can be reached without D2 and D4. Line 2 gives an example of what the power-frequency curve would look like without external inductor. The maximum power of Line 2 is higher but also the inception point is at twice the frequency. When combined, the two lines make the power frequency curve of the first scheme.

2. Scheme with External Inductance and Capacitance Parallel to the Generator

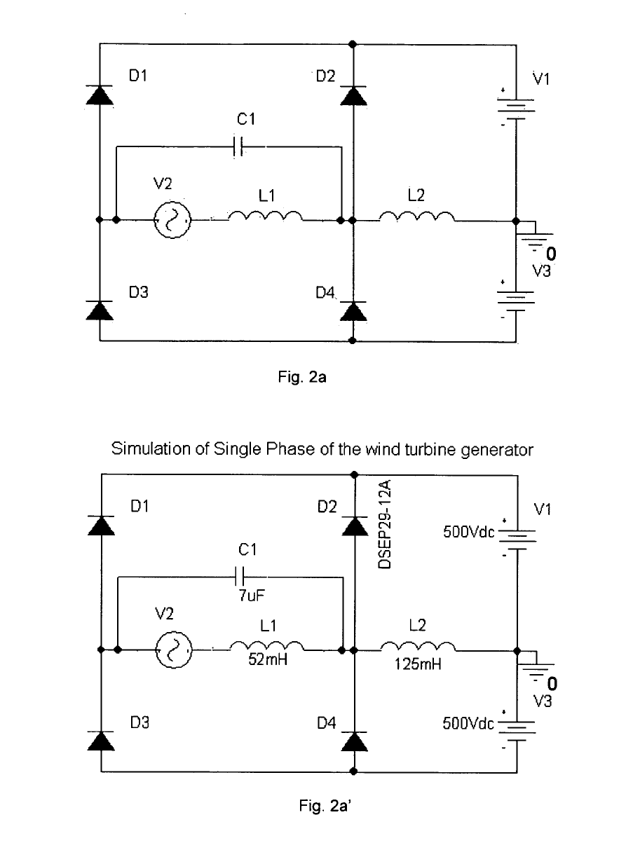

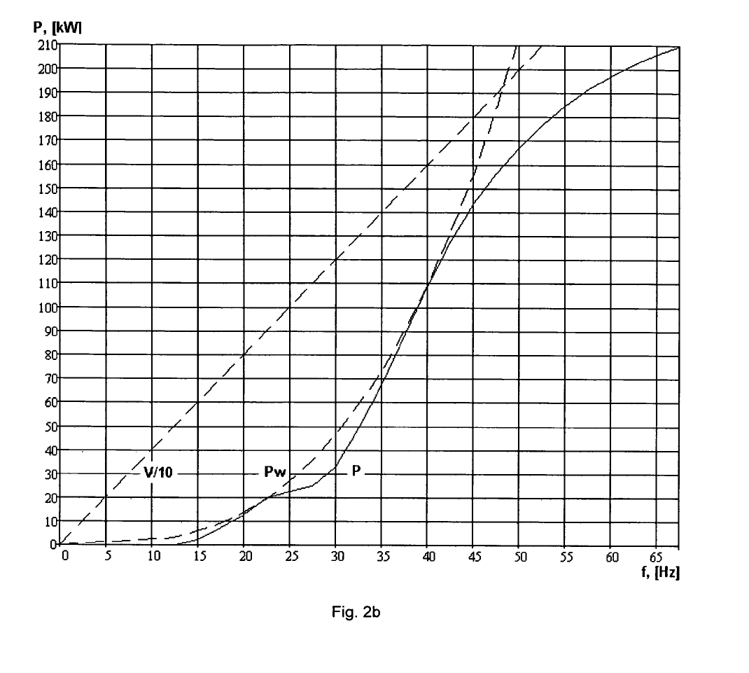

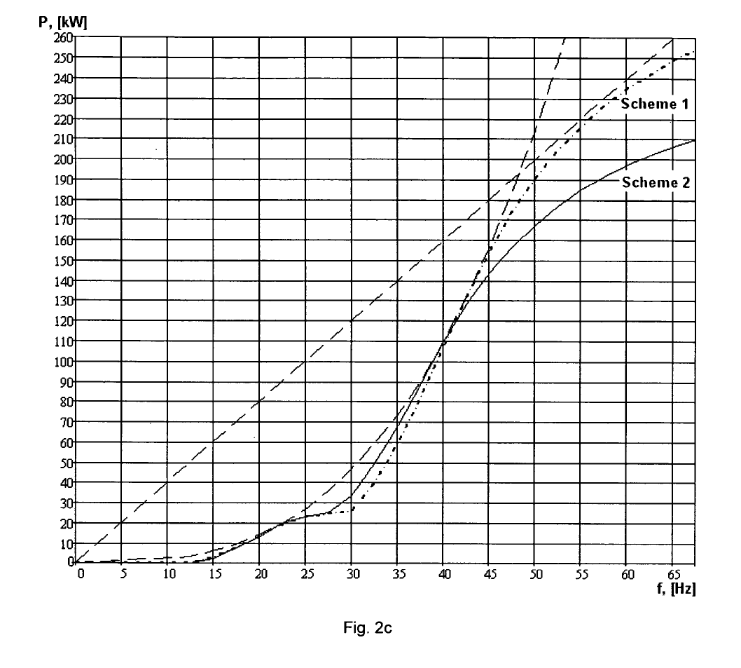

Scheme 2 (shown in FIG. 2a) has a capacitor connected in parallel to the generator. The circuit on FIG. 2a′ represents this concept with specified values used in the simulations and measurements. The values of the components in the scheme are:

1) Generator inductance—52 mH
2) External inductance—125 mH
3) Parallel capacitance—7 μF
3) EMF coefficient—40V/Hz
4) DC voltage—1000V

Although the capacitor is not large, it improves the power characteristics of the previous scheme. To keep the power-frequency curve under the ideal cubic curve the generators leakage inductor value is increased. Because of the relation between generators leakage inductor value and the size of the whole machine, this scheme reduces the size of the wind turbine generator.

FIG. 2b shows the power-frequency curve of the second scheme. The tuning of the scheme can be done in the same way as the first one. The power-frequency curve acts in the same way as the first circuit on changes in the values of external inductor, generator leakage inductor or generator EMF values.

The result of the comparison between the first two schemes is given on FIG. 2c. In the lower frequency area there is no difference, but at high frequencies the maximum power of the first scheme is higher. The actual gain of having a capacitor can be seen in the middle section of the power curve.

3. Scheme with External Capacitor

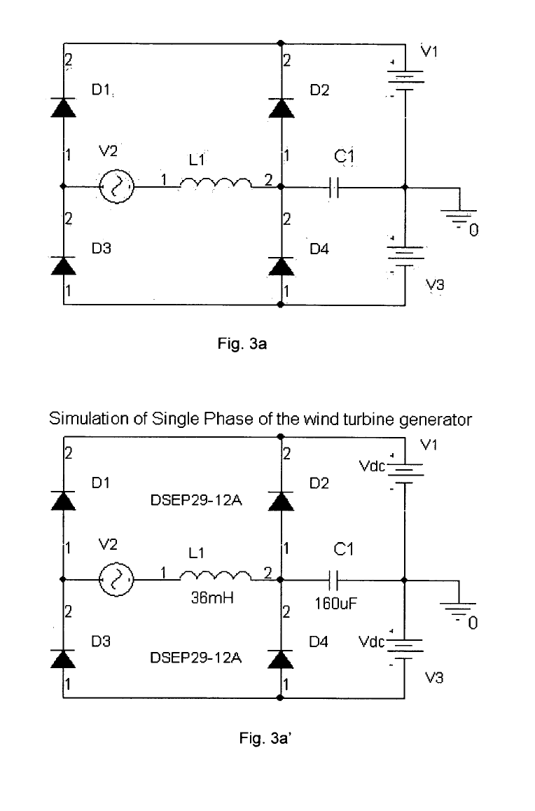

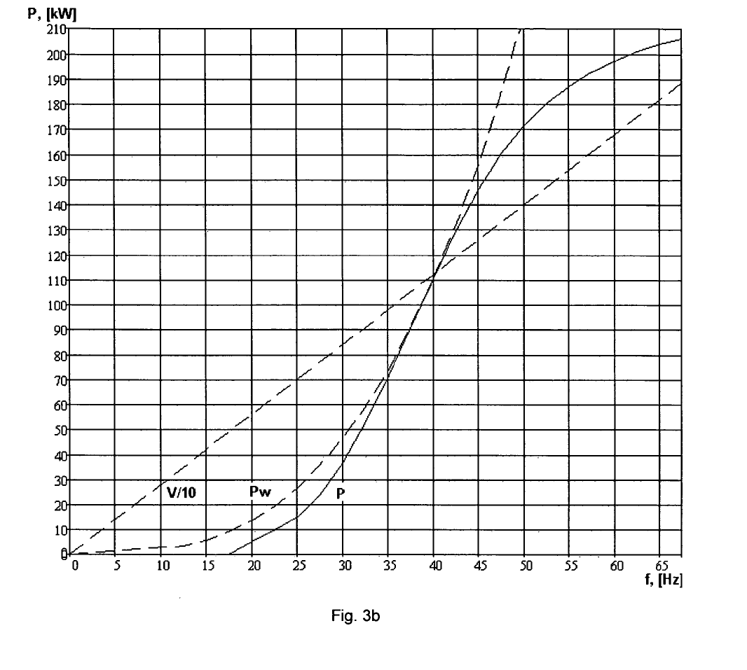

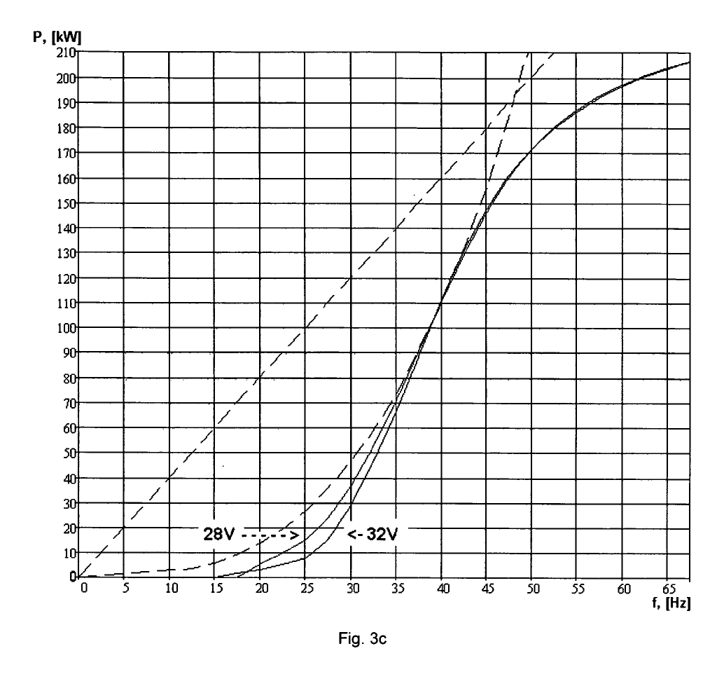

In FIG. 3a a capacitor replaces the inductor element of scheme 1. The circuit on FIG. 3a′ represents this concept with specified values used in the simulations and measurements. The values of the components in the scheme are:

1) Generator inductance—36 mH
2) External capacitance—160 μF
3) EMF coefficient—28V/Hz
4) DC voltage—1000V

FIG. 3b shows the power-frequency curve. The reason for the noticeable difference in the EMF value is that the power with standard 40V per Hz is much higher than the ideal cubic wind speed curve whatever the value of the capacitor and the generator leakage inductance are. Electromagnetic force values can be tuned accurately. With significant lower EMF this also means significantly smaller generator size which is advantageous.

The capacitor has not only an effect in the low frequency area but also on the slope at the higher frequencies. There is certain trade-off between maximum power and performance at low frequencies. It can be seen that the inception point is at higher frequencies. Again a trade-off must be made, this time between EMF value (generator size) and optimal power at low speeds. FIG. 3c shows direct comparison between 28V and 32V per 1 Hz.

4. Scheme with External Inductance and Transformer in Parallel to the Generator

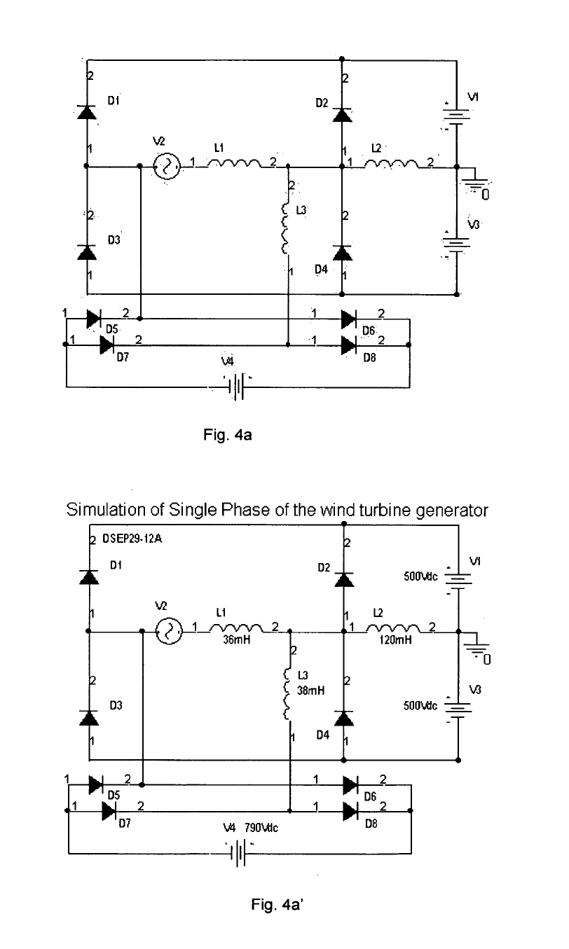

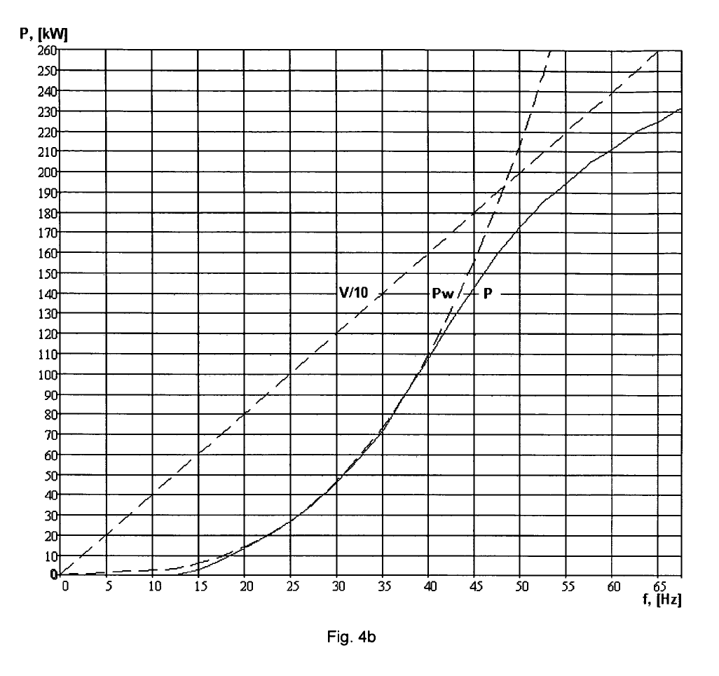

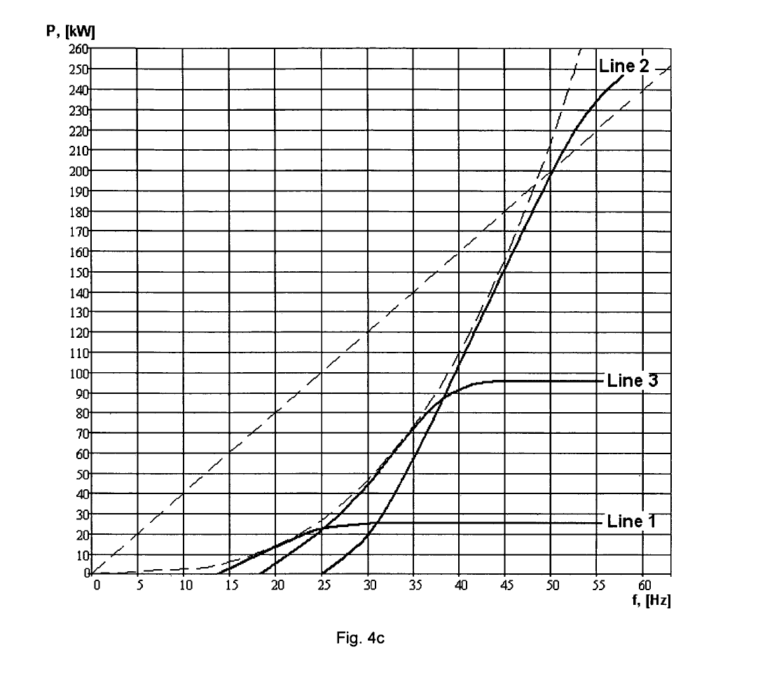

The circuit shown in FIG. 4a tries to make the middle area tunable. In this particular scheme a transformer parallel to the generator is used. The simulation of the transformer is done with an additional bridge rectifier, a DC voltage source and an inductor (which may be partly the inductance of the transformer). The circuit on FIG. 4a′ represents this concept with specified values used in the simulations and measurements. The values of the components in the scheme are:

1) Generator inductance—36 mH
2) Series transformer inductance—38 mH
3) External inductance—120 mH
4) EMF coefficient—40V/Hz
5) DC voltage—1000V
6) Second DC voltage—790V

With the transformer there will be a third line (FIG. 4c) tunable at both ends. At the low power side it is controllable by the DC voltage source which in practice is the transformers windings ratio. With such freedom to move it is possible to tune the third line to fit in the gap in the middle of the power curve from the first scheme (FIG. 2cError! Reference source not found.). The maximum power and the power at low frequencies are determined again by the generator leakage inductor and the external inductor as in the previous schemes.

FIG. 4b shows the resulting power-frequency curve: it is considerably closer to the ideal wind speed curve. However this solution has one major disadvantage: suitable transformers will be big and heavy. Also because of the three phases realization in practice there will be three transformers, increasing the cost.

5. Scheme with External Inductance Used as Magnetizing Inductor Parallel to Autotransformer.

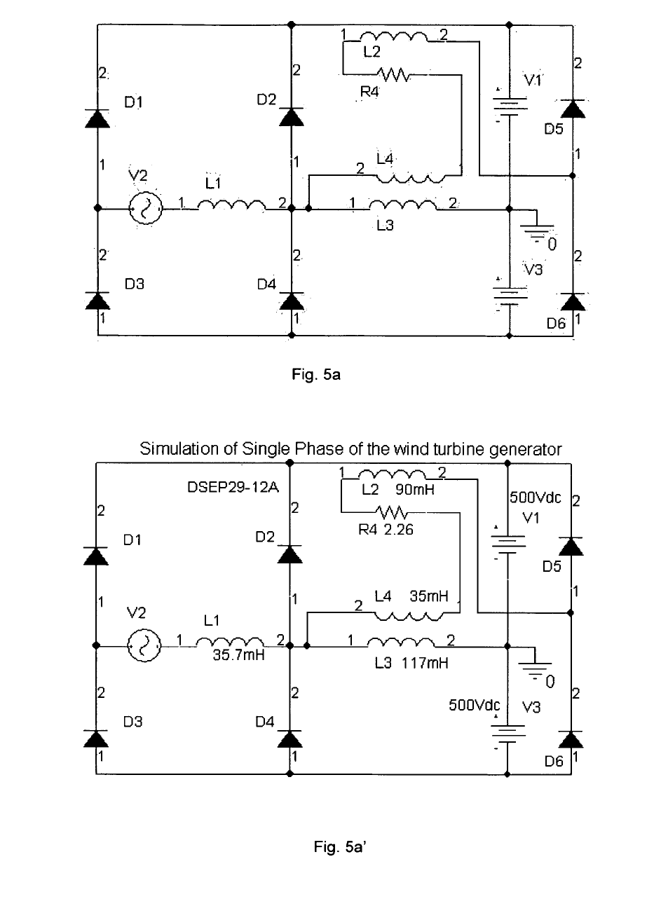

Scheme 5 (FIG. 5a) has been developed in order to solve the disadvantage of the previous circuit. A solution with an autotransformer parallel to the external inductor is proposed. If there is no need of galvanic separation, an autotransformer can be significantly smaller and lighter than a transformer. Also the inductor rating is only a small fraction of the generator rating. The values of the components as described in FIG. 5a′ are shown as an example.

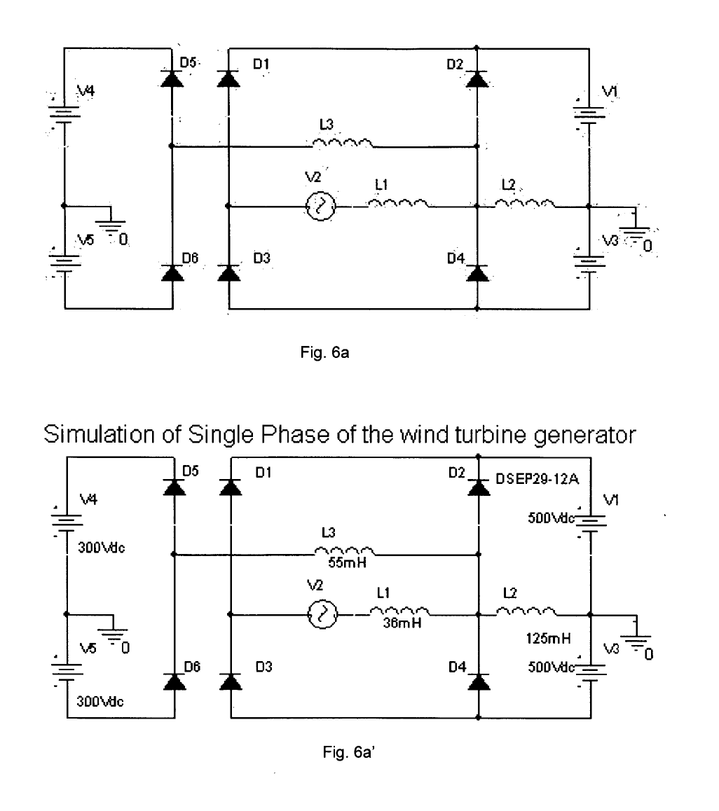

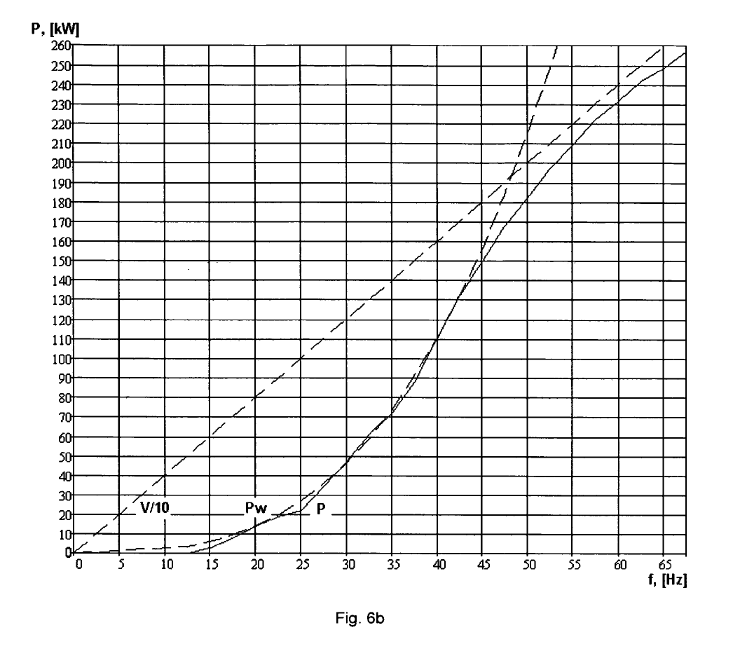

6. Scheme with Autotransformer (FIG. 6a).

The circuit on FIG. 6a′ represents this concept with specified values used in the simulations and measurements. The values of the components in the scheme are:

1) Generator inductance—35.7 mH
2) Primary magnetizing inductance—117 mH
3) Secondary magnetizing inductance—35 mH
4) Second winding external inductor value—90 mH
5) Resistor value—2.26Ω
6) EMF coefficient—40V/Hz
7) DC voltage—1000V

The curve that is obtained with this circuit is shown in FIG. 6b.

Another technique can be used to reduce the size and the number of inductors. The external inductor can be implemented by the magnetizing inductance of the autotransformer. The winding ratio of the autotransformer determines the inception point. This is used for tuning the middle area of the curve. The upper part of the middle area of the power line is determined by the inductor that is connected to the second winding of the autotransformer. The maximal power that can be obtained is dependent on the generator leakage inductance and it's EMF. At low frequencies, the magnetizing inductance of the autotransformer determines the power.

### Three-Phase Schemes

Several single phase schemes are illustrated in this text. Scheme 1 (FIG. 1a) is a cost effective solution even though no a perfect match is obtained. It is a basic scheme of the passive controlled wind turbine. Scheme 2 (FIG. 2a) with a capacitor in parallel with the generator has a better curve at the middle area but the maximum power is lower. Scheme 3 (FIG. 3a) with a capacitor in the star point has better middle area in the power curve, but is does not perform well at high and low frequencies. Scheme 4 (FIG. 4a uses a transformer in parallel to the generator to improve the power curve. This scheme is very close to the wind power curve, but this solution is not as cost-effective as the previous ones. Scheme 5 (FIG. 5a) is almost identical to 4 but uses an autotransformer, which reduces the cost.

In actual wind turbines, three phase circuits are needed. In the following three-phase versions are deducted from the previous single-phase equivalent schemes. The first proposed circuit is a very cost effective solution, the second example shows a very good fit with the optimal curve for maximum power point tracking but has more parts added, and hence is more expensive.

7. Three Phase Scheme with External Inductance Connected in Star Point

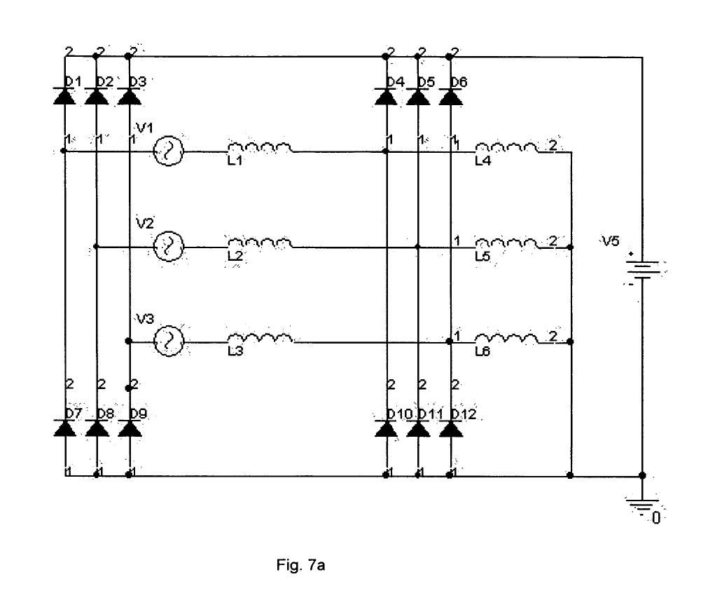

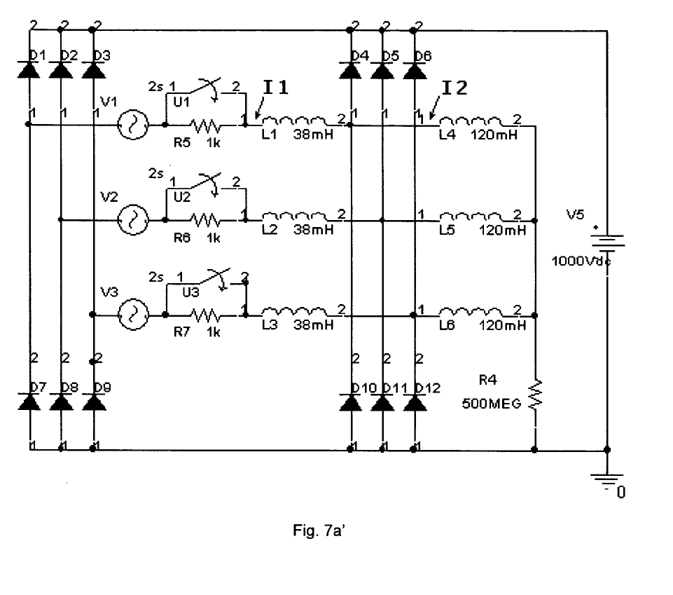

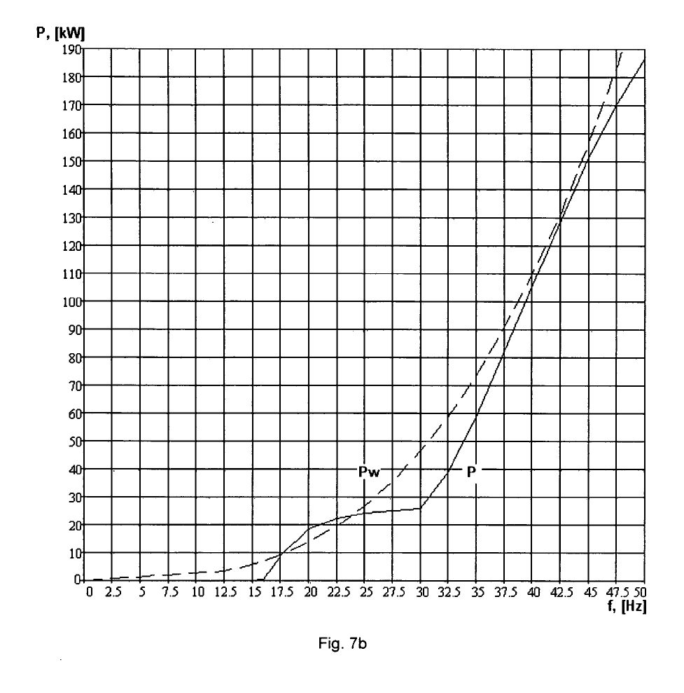

The circuit design (FIG. 7a) is tripled from the single phase scheme. The circuit on FIG. 7a′ represents this concept with specified values used in the simulations and measurements. The values of the components in the scheme are:

1) Generator inductance—3 inductors of 38 mH
2) External inductance—3 inductors of 120 mH
3) EMF constant—40V/Hz
4) DC voltage—1000V
5) Time dependant resistance—three resistors of 1 kΩ

The power-frequency curve that is obtained is shown on FIG. 7b. The resulting curve is a little different from the single-phase version. The inception point of the curve is higher than the examined single-phase scheme. The reason is that the inception point is determined by the line to line voltage exceeding the supply voltage. The resulting power curve is too high at low frequencies but this can be easily tuned with the value of the external inductances connected in the star point. At high frequency the curve is at small distance from the ideal third power wind speed curve. This is also tunable using the leakage inductance of the generator.

8. Three Phase Scheme with External Inductance Used as Magnetizing Inductor of an Autotransformer

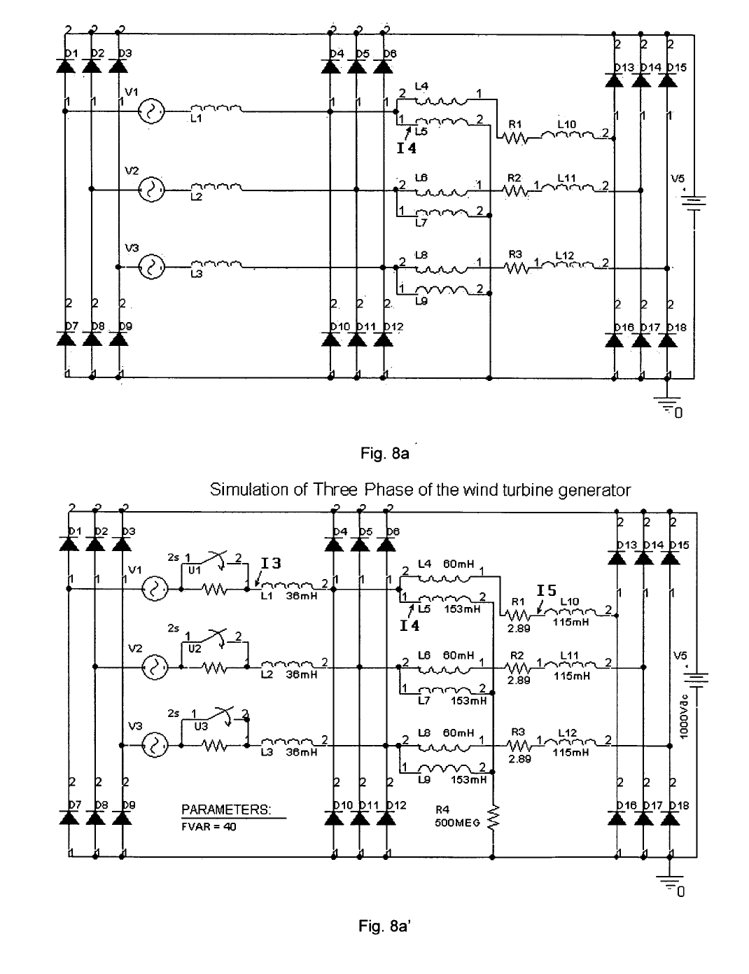

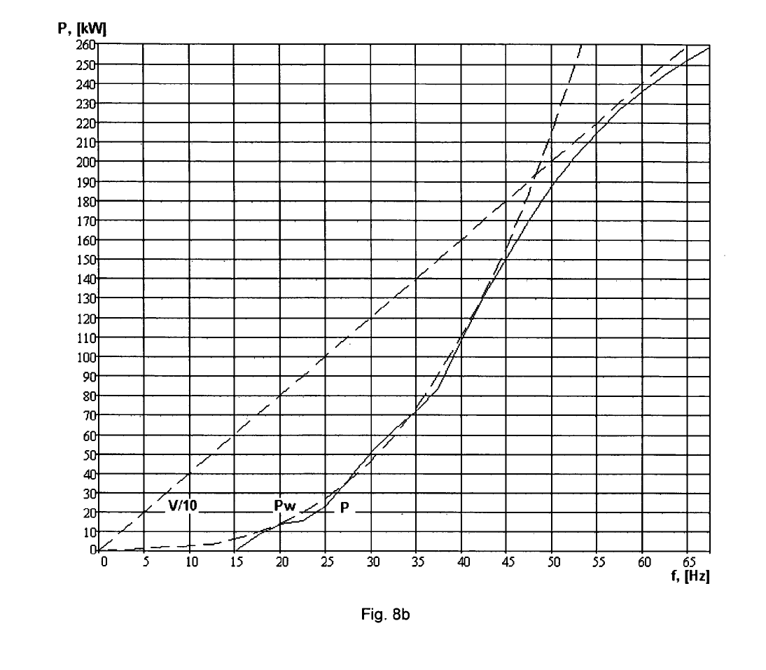

FIG. 8a is a tree-phase version of scheme 5. The circuit on FIG. 8a′ represents this concept with specified values used in the simulations and measurements. The values of the components in the scheme are:

1) Generator inductance—3 inductors of 36 mH
2) Primary magnetizing inductance—3 inductors of 153 mH
3) Secondary magnetizing inductance—3 inductors of 60 mH (coupling K=1 (ideal))
4) Second winding external inductor value—3 inductors of 115 mH
5) Resistor value—3 resistors of 2.89Ω
6) EMF coefficient—40V/Hz
7) DC voltage—1000V

The secondary inductance determines the autotransformer turns ratio. The turns ratio in this case is 2.5:1. All the effects of the first three-phase curve can be observed also in this scheme: a significant power increase in the low frequency range and a little gap from the ideal wind speed curve at high frequencies. FIG. 8b shows the resulting power-frequency characteristic.

### Braking Capacity

A very important part of the wind turbine passive control system is the braking capacity. On the one hand, the passive control system should be able to prevent the turbine from over-speeding by supplying sufficient torque once the rated rotational speed has been reached. On the other hand the circuit has to be able to act as an electrical brake in case the turbine needs to be stopped due to a failure or for maintenance purposes. Such an electrical brake will mostly operate in parallel with a mechanical brake but for large turbines each one of these braking mechanisms need to be able to keep the turbine below the maximum over-speed.

9. One Phase Braking Scheme with External Inductance Used as Magnetizing Inductor Parallel to Autotransformer

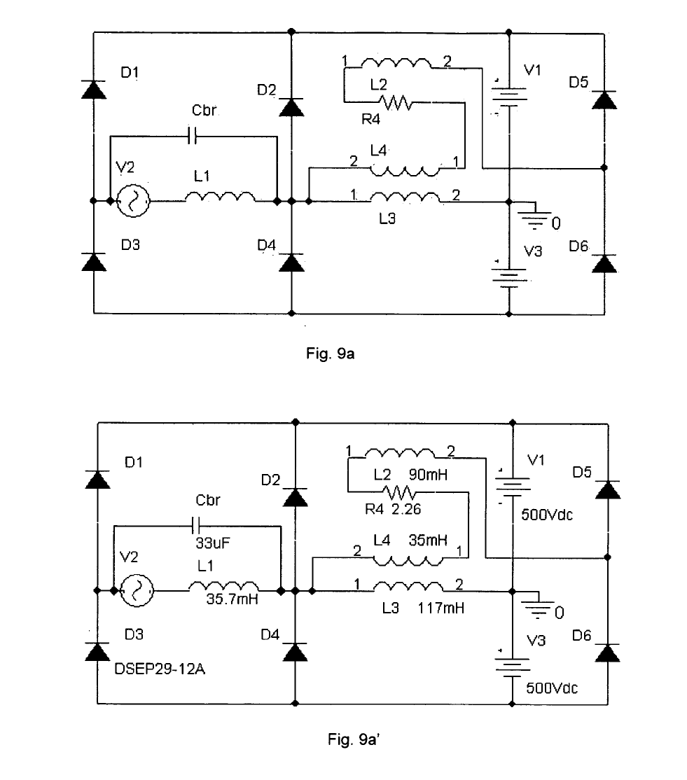

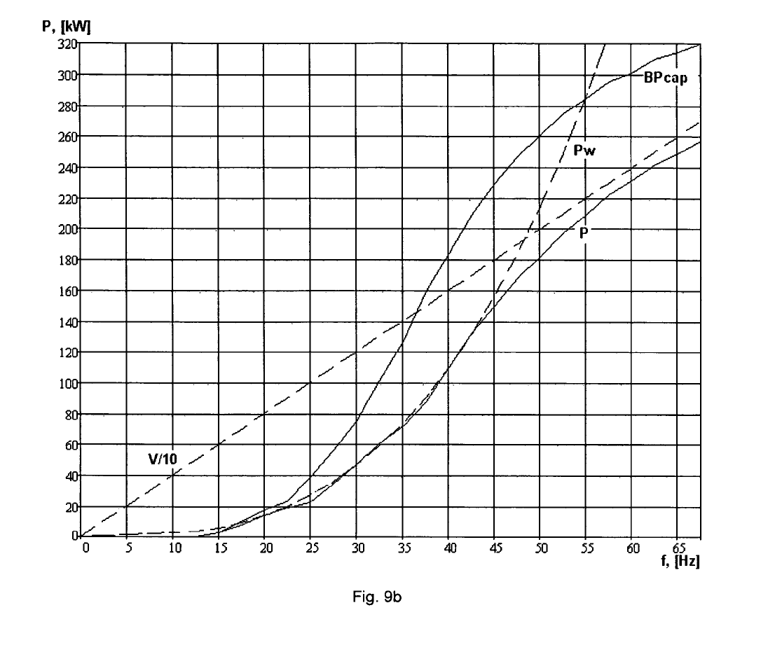

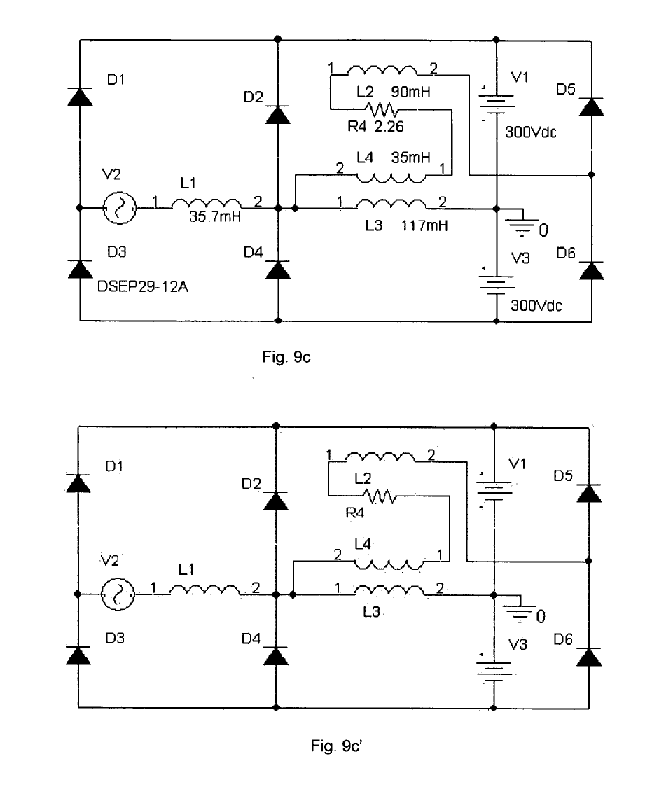

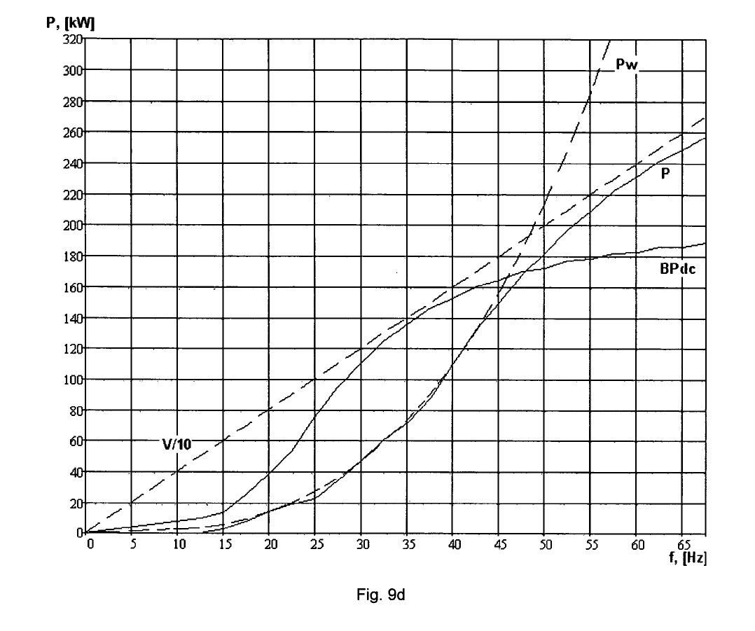

This scheme (FIG. 9a) was chosen as an example (a preferred embodiment) for presenting the braking schemes. It is a scheme with good characteristics in maximum power point tracking and with an acceptable level of complexity (parts count). The circuit on FIG. 9a′ represents this concept with specified values used in the simulations and measurements. The values of the components in the scheme are:

1) Generator inductance—35.7 mH
2) Primary magnetizing inductance—117 mH
3) Secondary magnetizing inductance—35 mH
4) Second winding external inductor value—90 mH
5) Resistor value—2.26Ω
6) Braking capacitor value—33 uF
7) EMF coefficient—40V/Hz
8) DC voltage—1000V

The obtained braking curve is shown in FIG. 9b. In this figure, the following abbreviations are used

Pw—ideal wind turbine power-frequency curve
P—Obtained power-frequency curve from scheme 5
V—Voltage proportional to the frequency
BPcap—braking power-frequency curve of scheme 9

It is noticeable that the braking curve is significantly above the wind power curve (dashed). The other power curve on the graphic is the power curve of scheme 5.

In order to provide sufficient torque (power) in all operating conditions the adopted design requirement was to have a power-frequency characteristic that lays at least 50% above the power curve of the scheme without the “braking parts” added. As shown in FIG. 9b, at high rotating speeds a brake like this should be enough to stop the turbine, however at low frequencies there is not enough power “in reserve” for stopping the wind turbine.

A solution than can be applied for electrical braking at low frequencies is to reduce the DC voltage (circuit shown in FIG. 9c). The circuit on FIG. 9c′ represents this concept with specified values used in the simulations and measurements. The values of the components in the scheme are:

1) Generator inductance—35.7 mH
2) Primary magnetizing inductance—117 mH
3) Secondary magnetizing inductance—35 mH
4) Second winding external inductor value—90 mH
5) Resistor value—2.26Ω
6) EMF coefficient—40V/Hz
7) DC voltage—600V

Because of the reduced voltage the diodes D1 and D3 conduct earlier. This means that an increased power is expected at the lower frequencies in the power curve. The value of the DC braking voltage is again chosen to increase the power by 50% above the scheme without braking.

In FIG. 9d the following abbreviations are used:

Pw—ideal wind turbine power-frequency curve
P—Obtained power-frequency curve from scheme 5
V—Voltage proportional to the frequency
BPdc—braking power-frequency curve of scheme 10

As it can be seen in FIG. 9d there is significantly more “braking” power at low and middle area. The maximum power however is reduced dramatically with the reducing of the DC voltage. There is also the possibility of switching to resistors with different values for obtaining a better braking power curve at all frequencies: at low frequencies a resistor with higher Ohmic value can be switched on and when the turbine has slowed down sufficiently another smaller valued resistor is switched on.

In conclusion the combination of these two possible electric brakes is capable of braking the wind turbine under all operating conditions. At high rotating speeds the capacitor can be used; starting from the medium-frequency range a resistor brake can be applied.

10. Three Phase Braking Scheme with External Inductance Used as Magnetizing Inductor Parallel to Autotransformer and Connected in Star Point

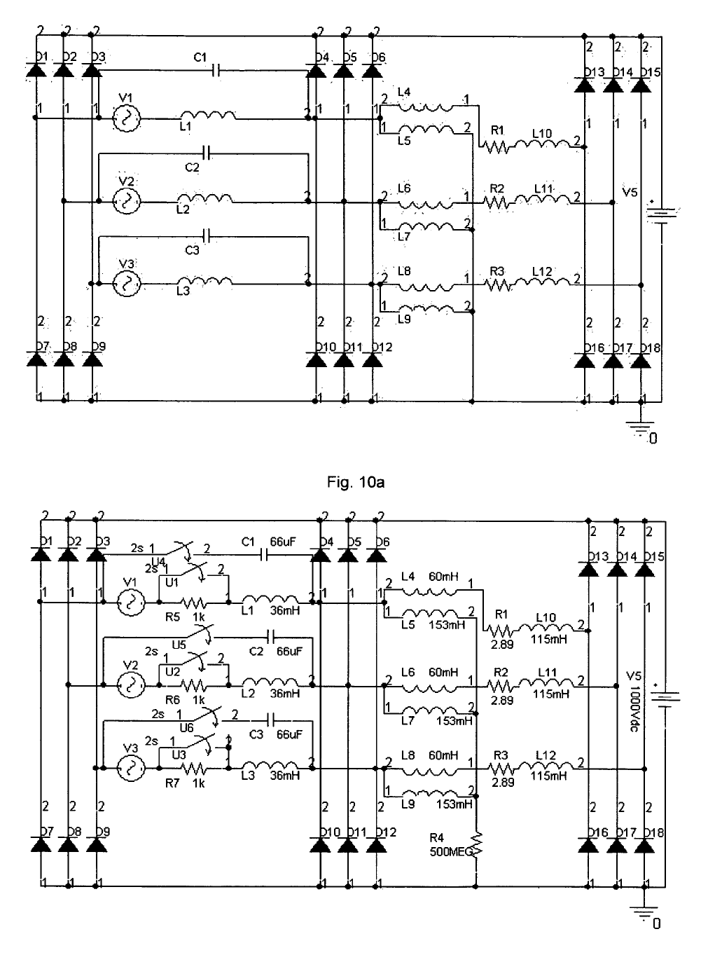

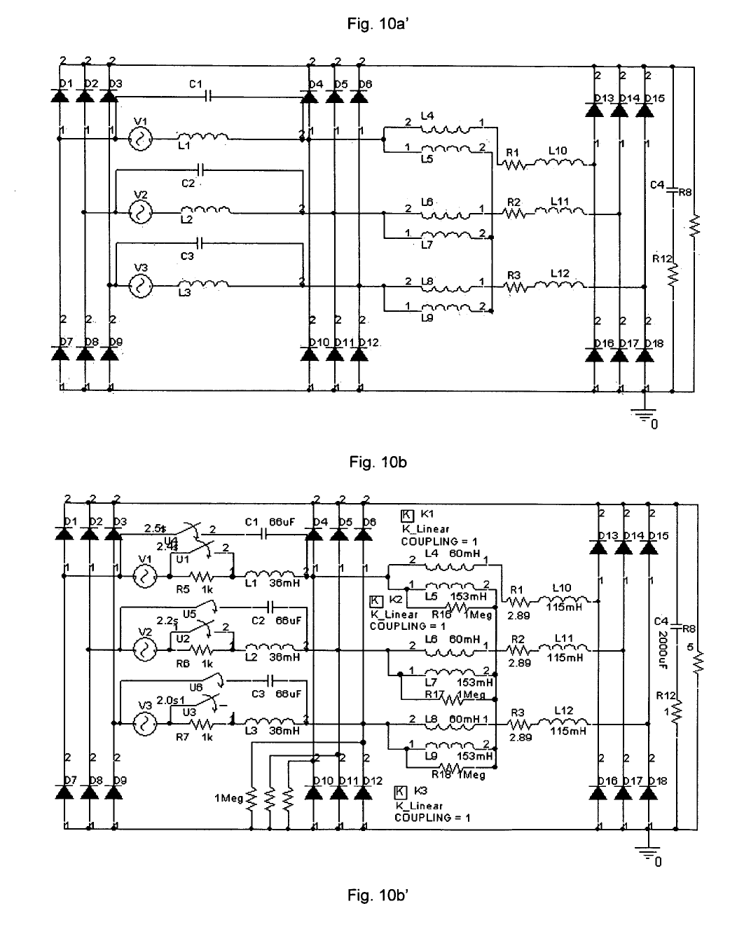

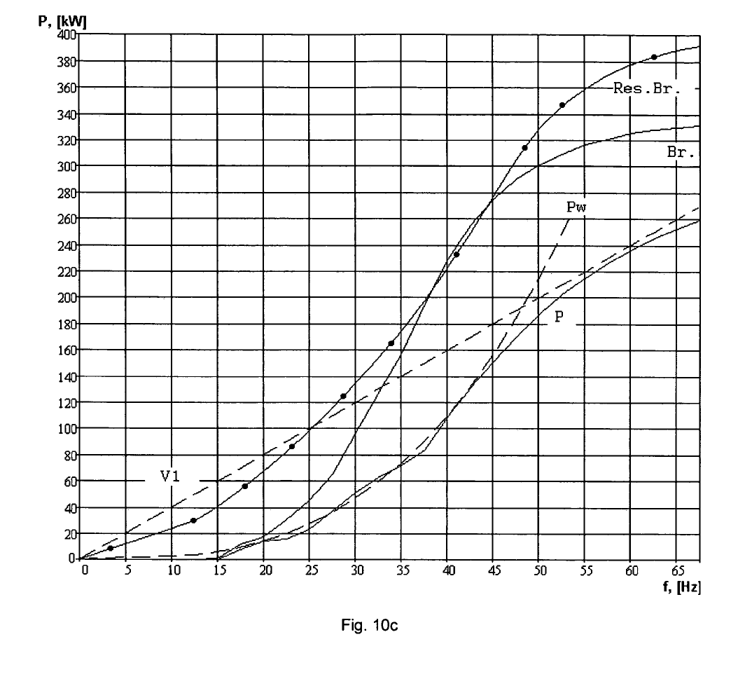

Scheme 10 (FIG. 10a) is three phase circuit with capacitors applied parallel to the three generator windings. This braking proves to be better at higher frequencies. The circuit on FIG. 10a′ represents this concept with specified values used in the simulations and measurements. The values of the components in the scheme are:

1) Generator inductance—3 inductors of 36 mH
2) Primary magnetizing inductance—3 inductors of 153 mH
3) Secondary magnetizing inductance—3 inductors of 60 mH (coupling K=1 (ideal) corresponding with a turns ratio 1:0,4)
4) Second winding external inductor value—3 inductors of 115 mH
5) Resistor value—3 resistors of 2.89Ω
6) Braking capacitor—3 capacitors of 66 μF
7) EMF coefficient—40V/Hz
8) DC voltage—1000V

Scheme 10b (FIG. 10b) shows a scheme of braking with a resistor. The value of the resistor in this simulation is constant. There is an option of changing its value if the obtained braking curve is not completely satisfactory. Schemes 10a′ (FIG. 10a′) and 10b′ (FIG. 10b′) are similar for almost all of the parts instead of the following added to scheme 11.

1) Filtering capacitor C4—2000 μF
2) Resistor load R8—5Ω

The braking power-frequency curve of scheme 10b seems to have plenty of braking capacity over the whole frequency range. The resistor is already enough to reduce the DC voltage to the desired level and reaching the necessary braking power.

The obtained braking curve is shown in FIG. 10c. In this figure, the following abbreviations are used:

Pw—ideal wind turbine power-frequency curve
P—Obtained power-frequency curve from scheme 8
V1—voltage proportional to the frequency
Br.—braking power-frequency curve of scheme 10a
Res.Br.—braking power-frequency curve of scheme 10b

1.-12. (canceled)

13. A method for maximum power point tracking approximation and speed control of a wind turbine; said method using at least one AC-DC converter for controlling the speed, said converter having an electrical circuit comprising solely passive components having tunable inductances and tunable capacitances.

14. The method of claim 13, wherein said converter comprises at least one inductor and at least one diode.

15. The method of claim 13, wherein said converter comprises at least one capacitor and at least one diode.

16. The method of claim 13, wherein said converter comprises at least one autotransformer and at least one diode.

17. The method of claim 13, wherein the passive components are tunable to load the generator output in such a way as to realize a pre-defined torque-frequency characteristic before installation of the wind turbine

18. The method of claim 13, wherein the passive components are tunable to load the generator output in such a way as to realize a torque-frequency characteristic after installation of the wind turbine.

19. The method according to claim 13, characterized in that the converter loads the generator output in such a way that the torque-frequency curve matches the ideal control law up to the rated rotor speed, which ideal control law matches power extracted from the generator to the maximum power available in the wind, and then implements a steep torque increase once the rated rotor speed has been reached to avoid turbine runaway.
